(19) United States
(12) Patent Application Publication
(10) Pub. No.: US 2023/0349380 A1
(43) Pub. Date: Nov. 2, 2023

(54) ORBITING SCROLL PLATE AND SCROLL COMPRESSOR

(71) Applicant: Robert Bosch GmbH, Stuttgart (DE)

(72) Inventors: Haixiang Wang, Shanghai (CN); Xiaofeng Gu, Shanghai (CN); Devin Yang, Shanghai (CN); Yong Huang, Shanghai (CN); Zhihao Ren, Shanghai (CN)

(21) Appl. No.: 18/309,094

(22) Filed: Apr. 28, 2023

(30) Foreign Application Priority Data
Apr. 29, 2022 (CN) 202221021041.5

(51) Int. Cl. F04C 18/02

(52) U.S. Cl. CPC F04C 18/0215; F04C 2240/20

(57) ABSTRACT

An orbiting scroll plate includes a base including a first side and a second side, and a scroll wrap attached to the base at the first side and having a spiral cross-section. The scroll wrap extends from a first end to a second end, the first end is positioned close to the outer side of the base, and the second end is positioned close to the center of the base. A return channel connects to and is in communication with the first side and the second side, and a release channel connects to and is in communication with the first side and the second side and positioned closer to the outer side of the base than the return channel is. The scroll wrap and the base are integrally constructed. A scroll compressor containing the orbiting scroll plate is also described.

### BACKGROUND

The present application relates to the field of scroll compressor structures. More particularly, the present application relates to an orbiting scroll plate, which is intended to provide a scroll compressor with improved performance under force during operation.

A scroll compressor generally includes an orbiting scroll plate and a fixed scroll plate. The orbiting scroll plate and the fixed scroll plate match each other in shape to jointly define a compression chamber. The orbiting scroll plate is driven by an external force to move relative to the fixed scroll plate, so as to continuously compress a gas from the outer portion to the inner portion. The compressed gas may be discharged from the compression chamber in an axial direction. Due to the existence of a pressure difference, the compression chamber will bear an acting force in the axial direction. A back-pressure channel may be provided to enable a part of the gas on a high-pressure side to move to a back-pressure chamber at the back side of the orbiting scroll plate, so that the orbiting scroll plate is located between the back-pressure chamber and the fixed scroll plate.

### SUMMARY

An objective of one aspect of the present application is to provide an orbiting scroll plate, which is intended to improve the performance of a scroll compressor under force during operation. An objective of another aspect of the present application is to provide a scroll compressor including the orbiting scroll plate.

The objectives of this application are achieved by means of the following technical solutions.

An orbiting scroll plate, including:
a base, including a first side and a second side;
a scroll wrap, attached to the base at the first side, and having a spiral cross-section, wherein the scroll wrap extends from a first end to a second end, the first end is positioned close the outer side of the base, and the second end is positioned close to the center of the base;
a return channel, connecting to and in communication with the first side and the second side; and
a release channel, connecting to and in communication with the first side and the second side, and positioned closer to the outer side of the base than the return channel is;
wherein the scroll wrap and the base are integrally constructed.

In the orbiting scroll plate, optionally, the second side of the base includes a seal ring installation portion close to the outer side of the base, and a bearing seat disposed around the center of the base, wherein the return channel is positioned within the bearing seat, and the release channel is positioned between the bearing seat and the seal ring installation portion.

In the orbiting scroll plate, optionally, the return channel extends and passes through the scroll wrap and the base from a top portion or sidewall of the scroll wrap in the proximity of the second end thereof.

In the orbiting scroll plate, optionally, the return channel extends and passes through the base from the first side of the base in the proximity of the second end of the scroll wrap.

In the orbiting scroll plate, optionally, the release channel extends and passes through the base from the first side of the base in the proximity of the first end of the scroll wrap.

In the orbiting scroll plate, optionally, the release channel extends and passes through the scroll wrap and the base from a sidewall of the scroll wrap in the proximity of the first end thereof.

In the orbiting scroll plate, optionally, the return channel and/or the release channel have a cross-section of one of the following shapes: a circle, triangle, rectangle, ellipse, rhombus, and trapezoid.

In the orbiting scroll plate, optionally, the release channel is constructed as a stepped hole, and includes a large-diameter portion and a small-diameter portion, wherein the length of the small-diameter portion is not more than half of the total length of the release channel.

A scroll compressor, including:
the orbiting scroll plate;
a housing;
a rotating shaft, disposed in the housing, and having an end to which the second side of the orbiting scroll plate is attached; and
a fixed scroll plate, attached to the housing and matching the orbiting scroll plate to form a compression chamber;
wherein a back-pressure chamber adjacent to the second side is formed around the rotating shaft, and is in fluid communication with the return channel and the release channel.

In the scroll compressor, optionally, the back-pressure chamber is disposed between the second side of the base and an intermediate disc of an installation bearing.

### BRIEF DESCRIPTION OF THE DRAWINGS

The following further describes this application in detail with reference to accompanying drawings and preferred embodiments. A person skilled in the art would understand that these accompanying drawings are only intended to facilitate understanding of the preferred embodiments, and should not be construed as limiting the scope of the present application. In addition, unless otherwise specified, the accompanying drawings are only intended to conceptually represent the composition or construction of the described objects and may include exaggerated displays. The accompanying drawings are also not necessarily drawn to scale.

FIG. 1 is a perspective view of one embodiment of an orbiting scroll plate according to the present application;

FIG. 2 is a cross-sectional view of the embodiment shown in FIG. 1; and

FIG. 3 is a partial cross-sectional view of one embodiment of a scroll compressor according to the present application.

### DETAILED DESCRIPTION

The following describes preferred embodiments of this application in detail with reference to accompanying drawings. A person skilled in the art would understand that these descriptions are only illustrative and exemplary, and should not be construed as limiting the scope of protection of the present application.

First, it should be noted that position terms mentioned in this specification such as top, bottom, upward, downward are defined relative to directions in the accompanying drawings. These positions are relative concepts, and thus may vary according to the position and state in which they are located. Therefore, these or other position terms should not be understood as limiting.

Further, it should further be noted that for any single technical feature described or implied in the embodiments herein or any single technical feature shown or implied in the accompanying drawings, these technical features (or equivalents thereof) can continue to be combined, thereby obtaining other embodiments that are not directly mentioned herein.

It should be noted that in different accompanying drawings, the same reference numbers indicate identical or substantially identical components.

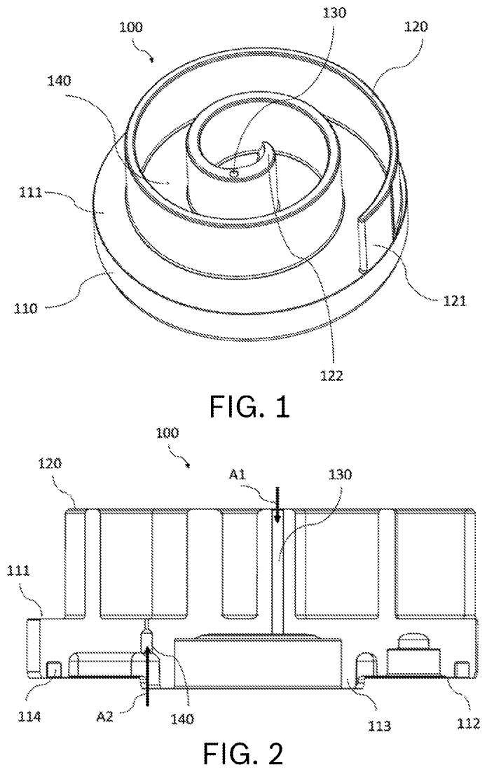

FIG. 1 is a perspective view of one embodiment of an orbiting scroll plate according to the present application, and FIG. 2 is a cross-sectional view of the embodiment shown in FIG. 1. An orbiting scroll plate 100 includes a base 110 and a scroll wrap 120.

The base 110 may be constructed to be generally circular or may be of other shapes. The base 110 may include a first side 111 and a second side 112. In the illustrated embodiment, the scroll wrap 120 may be attached to the base 110 at the first side 111. The base 110 may further include a bearing seat 113 and a seal ring installation portion 114. In one embodiment, the base 110 may include a center and an outer side. In a radial direction R, the outer side is closer to an edge of the base 110 than the center is. The bearing seat 113 may be positioned around the center of the base 110, and the seal ring installation portion 114 may be positioned close to the edge of the base 110. Thus, the bearing seat 113 is closer to the center of the base 110 than the seal ring installation portion 114 is.

The scroll wrap 120 may be of a spiral or swirl shape in an axial cross-section. In some embodiments, the scroll wrap may have a cross-section in the form of a nautiloid or a Fibonacci spiral. As shown in FIG. 1, the scroll wrap 120 may extend from a first end 121 to a second end 122. Here, the first end 121 is positioned close to the outer side of the base 110, and the second end 122 is positioned close to the center of the base 110. Accordingly, the scroll wrap 120 defines a helical flow path extending from the first end 121 to the second end 122, and the first end 121 is located upstream of the flow path, while the second end 122 is located downstream of the flow path. In this way, a spiral-shaped flow path is defined between the scroll wrap 120 and the base 110. In one embodiment, the scroll wrap 120 and the base 110 are integrally constructed. For example, the scroll wrap 120 and the base 110 may be integrally formed or manufactured.

A return channel 130 may be provided in the orbiting scroll plate 100, and disposed close to the center of the orbiting scroll plate 100. For example, the return channel 130 may extend to an back-pressure chamber (not shown) from a location in the proximity of the center of the orbiting scroll plate 100 so as to establish fluid communication between the back-pressure chamber and the center of the scroll plate 100. In other words, the return channel 130 may extend from the first side 111 to the second side 112 of the base 110 so as to establish fluid communication between the first side 111 and the second side 112 of the base 110. A working fluid or gas tends to flow in the return channel 130 in a direction indicated by an arrow A1. In one embodiment, the return channel 130 may be disposed within the bearing seat 113.

The release channel 140 may be provided in the orbiting scroll plate 100, and disposed close to the outer side of the orbiting scroll plate 100. In other words, the release channel 140 is located on the outer side of the orbiting scroll plate 100 relative to the return channel 130. For example, the release channel 140 may extend from the back-pressure chamber (not shown) to the flow path so as to establish fluid communication between the back-pressure chamber and the outer side of the orbiting scroll plate 100. In other words, the release channel 140 may extend from the first side 111 to the second side 112 of the base 110 so as to establish fluid communication between the first side 111 and the second side 112 of the base 110. A working fluid or gas tends to flow in the release channel 140 in a direction indicated by an arrow A2. In one embodiment, the release channel 140 may be disposed between the bearing seat 113 and the seal ring installation portion 114. Therefore, the release channel 140 is located closer to the outer side of the base 110 than the return channel 130 is.

In the illustrated embodiment, the return channel 130 is positioned downstream of the release channel 140. In other words, from the view of the flow path, the working fluid always tends to flow from a location in the flow path where the release channel 140 is located to a location in the flow path where the return channel 130 is located. In one embodiment, the return channel 130 is disposed close to the second end 122 of the scroll wrap 120. In one embodiment, the release channel 140 is disposed close to the first end 121 of the scroll wrap. In another embodiment, the return channel 130 and the release channel 140 are not located at the ends but are located at two locations in the flow path from the first end 121 to the second end 122. However, the release channel 140 is always located upstream of the return channel 130.

In one embodiment, the return channel 130 may extend from a lateral side or top of the scroll wrap 120, and extend all the way through the scroll wrap 120 and the base 110, and to the second side 112. In another embodiment, the return channel may extend from the first side 111 to the first side 111 in the proximity of the center of the base 110.

Similarly, in one embodiment, the release channel 140 may extend from the first side 111 to the second side 112 at a location other than the outer side or the center of the base 110. In another embodiment, the release channel may extend from a lateral side of the scroll wrap 120 at a location other than the outer side or the center of the base 110, and extend and pass through the scroll wrap and the base 110, and to the second side 112 finally.

The return channel 130 and the release channel 140 may be a hole. For example, the return channel 130 and the release channel 140 may have a cross-section of one of the following shapes: a circle, ellipse, rectangle, triangle, trapezoid, rhombus and the like. The return channel 130 and the release channel 140 may be made by a drilling and/or grinding process. The return channel 130 and the release channel 140 are not necessarily equal in area over an extended length thereof, but may vary in size. For example, the release channel 140 may be constructed in the form of a stepped hole. For example, the release channel 140 may include a large-diameter portion and a small-diameter portion, and the length of the small-diameter portion is not more than half of the total length of the release channel 140. The stepped hole facilitates the control of the amount of the released fluid. Further, the return channel 130 and the release channel 140 are positioned and configured such that they are in communication with each other only when the pressure differential reaches a certain amount.

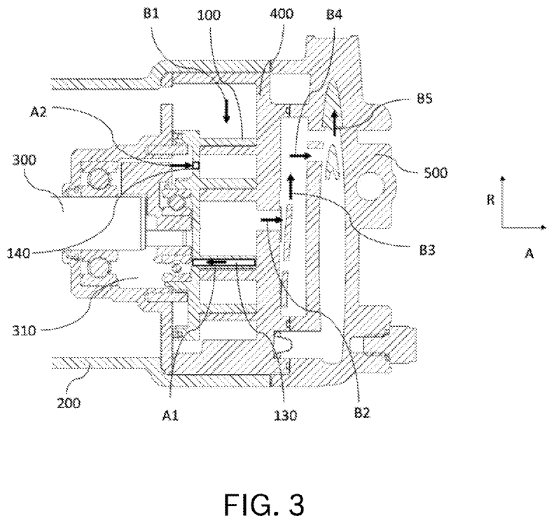

FIG. 3 is a partial cross-sectional view of one embodiment of a scroll compressor according to the present application. The scroll compressor includes an electrical driver (not shown), a rotating shaft 300, a housing 200, an orbiting scroll plate 100, a fixed scroll plate 400, and the like. The electrical driver may be coupled to the rotating shaft 300, and the rotating shaft 300 may be coupled to a second side 112 of the orbiting scroll plate 100. For example, an end of the rotating shaft 300 may be coupled to the second side 112 of the orbiting scroll plate 100, and is provided with corresponding components such as a bearing and a fixing member and the like. Accordingly, the electric driver may drive the orbiting scroll plate 100 to pivot relative to the housing 200. A back-pressure chamber 310 adjacent to the second side 112 of the orbiting scroll plate 100 is formed around the rotating shaft 300. The back-pressure chamber 310 is in fluid communication with the return channel 130 and the release channel 140.

In one embodiment, the return channel 130 may be positioned at the inner side of a bearing seat of the rotating shaft 300, and the release channel 140 may be positioned between the outer side of the bearing seat of the rotating shaft 300 and a seal ring. Thus, a space for accommodating a working fluid or gas is provided in the proximity of the bearing seat. Further, the back-pressure chamber 310 may be positioned between the second side 112 of the base 110 and an intermediate disc of an installation bearing. The installation bearing may be used, for example, for installing the rotating shaft 300.

Further, the scroll compressor may further include an end cap 500. A flow path is provided in the end cap 500 to receive the working fluid or gas exiting the compression chamber.

Particularly, the orbiting scroll plate 100 and the fixed scroll plate 400 match each other to jointly define a compression chamber therebetween. In use, the working fluid or gas may enter the compression chamber along the radial direction R in a direction indicated by an arrow B1, and flows between the orbiting scroll plate 100 and the fixed scroll plate 400. As the orbiting scroll plate 100 rotates, the working fluid or gas tends to gather towards the center of the compression chamber, and in this process, the pressure of the working fluid or gas rises gradually. At the center of the compression chamber, the working fluid or gas exits the compression chamber through an opening at the center of the fixed scroll plate 400, and enters the flow path in the end cap 500. For example, an arrow B2 shows that the compressed working fluid or gas exits the compression chamber in an axial direction A, and arrows B3, B4, and B5 show the flow direction in the end cap 500.

Similarly, at the center of the compression chamber, a portion of the compressed working fluid or gas enters the return channel 130, and moves in the direction indicated by the arrow A1. This portion of the working fluid or gas will enter the back-pressure chamber 310, and then return to the compression chamber through the release channel 140 in the direction indicated by the arrow A2. In this way, the pressures on both sides of the compression chamber in the axial direction A may be balanced at least to a certain extent, thus reducing an axial pressure differential in the proximity of the compression chamber, and reducing the wear from mechanical operation.

The axial direction A referred to herein refers to a direction in which the axis of symmetry of the rotating shaft 300 is located. The radial direction R referred to herein refers to a direction in which a ray emanating from the axial direction A and perpendicular to the axial direction A is pointed. Arrows on the right side of FIG. 3 schematically illustrate the axial direction A and the radial direction R.

The orbiting scroll plate and the scroll compressor of the present application have the advantages of simple structures, reliable operation, easy implementation, and the like. By adopting the technical solutions of the present application, the performance of the scroll compressor under force is improved, and the reliability is increased.

This specification discloses this application with reference to the accompanying drawings, and also enables a person skilled in the art to practice this application, including manufacturing and using any apparatus or system, selecting appropriate materials, and using any incorporated method. The scope of this application is defined by the technical solutions claimed, and includes other examples that occur to a person skilled in the art. As long as such other examples include structural elements that are not different from the literal language of the claimed technical solution, or such other examples include equivalent structural elements that do not substantially different from the literal language of the claimed technical solution, such other examples should be considered within the scope of protection determined by the technical solutions claimed in this application.

1. An orbiting scroll plate, comprising:
a base (110), comprising a first side (111) and a second side (112);
a scroll wrap (120), attached to the base (110) at the first side (111), and having a spiral cross-section, wherein the scroll wrap (120) extends from a first end (121) to a second end (122), the first end (121) is positioned close to an outer side of the base (110), and the second end (122) is positioned close to a center of the base (110);
a return channel (130), connecting to and in communication with the first side (111) and the second side (112); and
a release channel (140), connecting to and in communication with the first side (111) and the second side (112), and positioned closer to the outer side of the base (110) than the return channel (130) is;
wherein the scroll wrap (120) and the base (110) are integrally constructed.

2. The orbiting scroll plate according to claim 1, wherein the second side (112) of the base (110) comprises: a seal ring installation portion (113) close to the outer side of the base (110), and a bearing seat (114) disposed around the center of the base (110), wherein the return channel (130) is positioned within the bearing seat (114), and the release channel (140) is positioned between the bearing seat (114) and the seal ring installation portion (113).

3. The orbiting scroll plate according to claim 1, wherein the return channel (130) extends and passes through the scroll wrap (120) and the base (110) from a top portion or sidewall of the scroll wrap (120) in a proximity of the second end (122) thereof.

4. The orbiting scroll plate according to claim 1, wherein the return channel (130) extends and passes through the base (110) from the first side of the base (110) in a proximity of the second end (122) of the scroll wrap (120).

5. The orbiting scroll plate according to claim 1, wherein the release channel (140) extends and passes through the base (110) from the first side (111) of the base (110) in a proximity of the first end (121) of the scroll wrap (120).

6. The orbiting scroll plate according to claim 1, wherein the release channel (140) extends and passes through the scroll wrap (120) and the base (110) from a sidewall of the scroll wrap (120) in a proximity of the first end (121) thereof.

7. The orbiting scroll plate according to claim 1, wherein the return channel (130) and/or the release channel (140) have a cross-section of one of the following shapes: a circle, triangle, rectangle, ellipse, rhombus, and trapezoid.

8. The orbiting scroll plate according to claim 1, wherein the release channel (140) is constructed as a stepped hole, and comprises a large-diameter portion and a small-diameter portion, wherein a length of the small-diameter portion is not more than half of a total length of the release channel (140).

9. A scroll compressor, comprising:
the orbiting scroll plate (100) according to claim 1;
a housing (200);
a rotating shaft (300), disposed in the housing (200), and having an end to which the second side (112) of the orbiting scroll plate (100) is attached; and
a fixed scroll plate (400), attached to the housing (200), and matching the orbiting scroll plate (100) to form a compression chamber;
wherein a back-pressure chamber (310) adjacent to the second side (112) is formed around the rotating shaft (300), and is in fluid communication with the return channel (130) and the release channel (140).

10. The scroll compressor according to claim 9, wherein the back-pressure chamber (310) is disposed between the second side (112) of the base (110) and an intermediate disc of an installation bearing.
